(19) United States
(12) Patent Application Publication
(10) Pub. No.: US 2003/0075532 A1
(43) Pub. Date: Apr. 24, 2003

(54) Circuit formation by laser ablation of ink

(75) Inventors: Jonathan Charles Salmon, Edinburgh (GB); Robert William Charles Gusthart, Tranent (GB); Rogers Beetlestone, Pulborough (GB)

Correspondence Address: LAHIVE & COCKFIELD, 28 STATE STREET, BOSTON, MA, 02109, US

(73) Assignee: Sigtronics Limited, Livingston (GB)

(21) Appl. No.: 10/213,333

(22) Filed: Aug. 5, 2002

(30) Foreign Application Priority Data
Oct. 22, 2001 (GB) 0125350.9

(51) Int. Cl. B05D 5/12; B05D 1/36; B05D 3/00; B23K 26/38; B23K 26/42

(52) U.S. Cl. 219/121.69; 427/555; 427/271; 427/58; 427/402; 219/121.68

(57) ABSTRACT

There is disclosed a method of forming conductive tracks on a substrate using a laser ablation technique in order to produce Printed Circuit Boards (PCBs). The method involves the initial step of coating a substrate such as alumina substrate with a conductive ink to create a conductive ink layer. Subsequent to this, a laser spot is focussed onto the ink in order to ablate a portion of the ink layer from the substrate to define tracks of ink, which are then cured.

Also disclosed is a method of forming multiple layers of conductive tracks on a substrate, each layer of conductive tracks being separated by a layer of cured dielectric ink. The method involves and sequentially coating, ablating, and curing alternate dielectric and conductive ink layers on a substrate incorporating cured tracks of ink produced by the method noted above.

An apparatus for use in the method is also disclosed.

The present invention relates to a method and apparatus for producing conductive tracks on a substrate by ablating conductive ink from the surface of a substrate using a laser, and in particular, but not exclusively, using a pulsed laser.

The present invention also relates to a method and apparatus of producing multiple layers of conductive tracks on a substrate.

Electronic products often contain a number of functional circuits which are formed into a single unit. Such units may be Printed Circuit Boards (PCBs) or hybrid circuits, which are generally composed of conductive ink tracks disposed on a substrate. PCBs and hybrid circuits are essentially similar, differing only in the type of substrate and inks used and the typical track dimensions. PCB tracks typically range from 100 microns to 300 microns wide, whereas hybrid circuit tracks may be less than 75 microns, and ideally 50 microns wide.

The direct patterning of PCBs and hybrid circuits is a difficult process, normally involving the removal of unwanted material from the surface of a conductor-coated substrate to leave the required conductive track pattern. A number of methods exist to remove unwanted material such as etching, machining, chemical burning, and more recently, ablation.

Ablation involves the loss or removal of material by an erosive process such as melting or vaporisation which require heat to be accurately introduced into the material. Lasers are commonly used for this purpose as heat may be generated within the material by absorption of the laser wavelength from a focussed laser spot incident on the material. However, when PCBs or hybrid circuits are manufactured from copper clad materials, such as substrates covered with copper foil, the choice of laser is limited. This is due to the high reflectivity of copper, particularly in the infra red and visible ranges of the spectrum which precludes lasers producing such wavelengths, which are relatively cheap. Additionally, the high thermal conductivity of copper increases the required laser intensity and thus the required power for ablation. To solve these problems with copper clad boards, the industry currently utilises expensive and power limited ultra violet lasers to enable machining of copper and, more recently, dual-laser systems to enable high speed machining of substrate materials in the infra-red where relatively cheap lasers are available. The requirement for an ultra violet laser is a major factor in the cost of the production of PCBs or hybrid circuits by this method, and in the limited throughput achievable.

It is an object of the present invention to obviate or mitigate at least one of the aforementioned disadvantages by providing a method of PCB and hybrid circuit manufacture which allows the use of a wide selection of lasers.

According to a first aspect of the present invention, there is provided a method of creating a three-dimensional structure on a surface, said method comprising the steps of:

coating a surface with ink to create an ink layer; and

ablating a portion of the ink layer from said surface using a laser to define said three-dimensional features in the remaining ink layer.

According to a second aspect of the present invention there is provided a method of forming conductive tracks on a substrate, the method comprising the steps of:

coating a substrate with conductive ink to create a conductive ink layer;

ablating a portion of the ink layer from the substrate using a laser to define tracks of ink; and

curing said tracks of ink.

Thus, by moving a laser focal-spot relative to the substrate with the conductive ink layer, a Printed Circuit Board (PCB) or a hybrid circuit is created by removing unwanted ink. The remaining ink, principally in the form of tracks, is cured to produce a conducting and solderable circuit that is bonded to the substrate.

The substrate upon which the ink layer is coated may be an alumina substrate, for example. Alternatively, the substrate may be FR4 board or other suitable material.

Preferably, the ink comprises a paste loaded with conductive particles such as, for example, metallic particles. The conductive particles may be gold particles, for example, or other metallic particles such as silver or copper or the like. Alternatively, the paste may be loaded with non-metallic conductive particles such as carbon particles, for example. Preferably, the paste includes a solvent which can be used to provide the required “wetness” or viscosity of the paste. For example, a higher solvent content will produce a lower viscosity and a “wetter” paste. Additionally, the type of solvent used may have an effect on the viscosity of the paste. Preferably also, the paste includes fluxes and polymers, the selection of which may also effect the viscosity of the paste. Consequently, where a laser beam is incident on the ink layer, the laser wavelength is absorbed by the ink which rapidly superheats the ink causing vaporisation of the solvent/fluxes/polymers and expulsion of the conductive particles from the substrate surface. Additionally, in order to assist in the bonding of the ink constituents, a solder material may be provided such as, for example, a silver solder material.

Preferably, where the process is used in PCB manufacture, the ink used comprises copper particles having a diameter of up to 40 microns, and is coated onto a polyimide substrate or FR4 board or the like having a thickness of between 0.3 mm and 1.6 mm.

Preferably also, where the process is used in the manufacture of hybrid circuits, the ink used comprises gold particles of around 1 to 2 microns in diameter, and is coated onto a ceramic substrate, or alumina substrate, for example.

When a laser spot is focussed onto an ink layer deposited on a substrate, the ink will be ablated down to the level of the substrate, which substrate acts as a stopper layer.

As the energy required for vaporisation of the solvent, flux and polymer components of the paste is substantially lower than that of copper foil, for example, the ink exhibits a relatively low ablation threshold. That is, the bonding within the individual component parts of the paste are weak in comparison to direct metallic bonding. A further advantage of the conductive ink over copper foils is its wide absorption band, which includes the entire visible and near infra-red spectrum. This removes the requirement for expensive and power limited ultra-violet lasers which are currently required to overcome the problems arising from the high reflectivity and thermal conductivity of copper, which precludes the use of commonly available infra-red and visible lasers and increases the ablation threshold of copper foils.

The conductive ink may be ablated while wet as wet ink has a relatively high solvent content which provides a lower ablation threshold, allowing easier vaporisation and material removal. This low threshold is due to the solvents in the ink evaporating explosively when a high energy intensity laser spot is focussed thereon, thus readily expelling the metallic particles. However, should the ink be too wet, the corresponding low viscosity may cause slumping of the ink into those areas where ink has been removed. This may, therefore, affect the minimum track size achievable, as a degree of smearing of the ink tracks may occur.

Preferably, the ink, when applied to the substrate, has a relatively high viscosity sufficient to prevent, or at least minimise, the degree of slumping during an ablation process.

More preferably, the conductive ink layer may be dried before the ink is ablated to prevent the aforementioned slumping into ablated regions. Drying the ink layer does not involve curing but merely evaporating the solvent from the paste to leave the ink layer in a substantially solid state. The ink may be dried in ambient air conditions, or alternatively in an oven which produces a more uniform and consistent finish which results in improved curing.

Preferably, and particularly in PCB manufacture, the ink is dried in an oven at a temperature of around 100° C. to 150° C. for around 10 to 15 minutes.

Preferably also, in PCB production, when the ink is initially coated onto the substrate, an ink layer having a thickness of approximately 75 to 100 microns is produced. When the ink layer is dried, preferably the thickness reduces to approximately 60 to 90 microns due to the evaporation of the solvent from the paste.

Conveniently, in hybrid circuit manufacture, the ink is dried in an oven at a temperature of around 150° C. for approximately 10 minutes.

Preferably also, in hybrid circuit manufacture, when the ink is initially coated onto the substrate, an ink layer having a thickness of approximately 16 microns is produced. When the ink layer is dried, preferably the thickness reduces to approximately 9 to 12 microns.

With fully dried ink, the limiting factor on track size is dependent on the minimum particle size within the ink. Since the process depends upon the ejection of entire conductive particles, it is preferred that a smaller maximum particle size is used which provides for ultimately finer tracks and smoother track edges. Preferably, conductive particles having a diameter of approximately 1 to 2 microns are used in the conductive paste which as noted above is preferred in hybrid circuit production. However, the process may be used with conductive particles having a diameter of up to 40 microns, preferred for PCB manufacture, with associated reductions in fine track features.

When curing the conductive ink, it is required to introduce heat rapidly thereto to achieve liquid phase sintering and polymer cross-linking. Conveniently, the ink is cured in an oven such as a convection oven, conveyor type oven, vapour phase oven or infra-red oven, for example. Preferably, hybrid circuit conductive ink is cured at a temperature of around 850° C. for around 10 minutes when gold particles are present. Preferably also, in PCB manufacturing where ink comprising copper particles is used, for example, curing is achieved at a temperature of around 195° C. Typically, PCB conductive ink is cured in an oven in a nitrogen atmosphere which is ramped up to 195° C. over a period of 30 minutes, and the temperature is maintained for around 15 minutes. Preferably, the ink, once cured, is allowed to cool to ambient temperatures over approximately 12 minutes.

Alternatively, the ink may be cured by use of a de-focussed laser spot scanned over the tracks of ink defined by the ablation process. This will heat the ink to a sufficient temperature to initiate curing, but will not exceed the ablation threshold temperature.

When cured, the thickness of the ink layer used in hybrid circuit manufacture, that is, the thickness of the conductive tracks, is preferably reduced to approximately 5 to 8 microns.

Additionally, the thickness of the ink layer in PCB manufacture is reduced to approximately 60 to 90 microns when cured.

The conductive ink may be ablated by use of a low power continuous wave (CW) laser such as a diode laser or CO₂ laser which produces long, low peak-power pulses. However, use of a CW laser may lead to burning of the surrounding ink because the energy required to burn off the ink is supplied relatively slowly, allowing time for the energy to be thermally conducted out of the target area. Scorching and heat damage may also be observed to the substrate.

Preferably, the conductive ink is ablated by use of a pulsed laser which reduces the thermal problems associated with the high energy levels required for ablation. A pulsed laser produces discrete energy pulses having high peak powers and therefore accurately removes the targeted ink almost instantaneously without allowing sufficient time for thermal energy to be conducted into the surrounding area to induce burning.

The pulsed laser may be, for example, a Q-switched solid state laser such as a Nd³⁺:YAG laser which produces a short energy burst of a very high intensity.

Since the process involves the removal of unwanted ink, the minimum track size is not dependent on the laser spot size but on the accuracy of positioning the laser spot, since the laser spot only defines the gaps between the tracks and the edges thereof. Preferably, the laser ablation method as described herein produced a minimum track size of 25 microns and below.

As noted above, the spot size determines the gap width between tracks. It is normal for the power intensity of the laser to vary within the spot itself, and thus, the gap width is determined by the effective spot size; that is, that area of the spot whose intensity exceeds the ablation threshold of the conductive ink.

Preferably, the laser comprises a high quality laser beam with a Gaussian intensity profile. This allows for improved control over the effective spot size by varying the power, as only the inner core of the spot will have peaked above the ablation threshold. In this way, tip processing can be used where only the peak intensity causes ablation of the material, leading to an ablated line width which is smaller than the diameter of the laser spot. Preferably, the laser spot produces gap widths of below 75 microns, and more preferably produces gap widths of 50 microns and below. For example, a 25 W average power Q-switched Nd:YAG laser with a spot size of 64 microns in diameter, a repetition rate (time between pulses) of 5 kHz and a pulse duration of 42 nanoseconds produces an ablated line width of 50 microns.

A typical pulsed laser has a number of parameters which may be dependent on each other, and may thus be selected or controlled in accordance with the required operation of the pulsed laser. Such parameters include:

the linear scanning speed, which defines the speed at which a laser spot travels along a target surface, measured in unit distance per unit time;

the pulse length, which defines the time length of the laser pulses;

the pulse repetition rate, which defines the time length between laser pulses;

laser power, which defines the actual power of the laser;

peak power, which defines the maximum power level reached during a short pulse. This quantity is higher than the average power level of a Q-switched laser, for example;

the spot size, which defines the actual diameter of the laser spot incident on the target surface;

the effective spot size, which defines the diameter of the area within the laser spot whose intensity is greater than the ablation threshold of the conductive ink; and

the pulse spacing, which defines the distance travelled by the laser focal spot relative to the target between laser pulses.

Preferably, a maximum pulse spacing on the target of half the effective spot size is required to obtain a continuous ablated area to produce tracks with uniform track edges.

Preferably also, the maximum linear scan speed for a given repetition rate is the effective spot radius (effective spot size/2) multiplied by the repetition rate of the laser. For example, a 10 kHz laser beam can be used to cut a 100 micron track at 0.5 ms⁻¹, or a 200 micron track at 1 ms⁻¹. In comparison, the use of a 20 kHz beam will double these maximum speeds. However, although these are the maximum speeds attainable with a specific repetition rate, the actual speed attainable then relies on the available peak power. The dependence of the maximum linear scan speed on the peak power is a more complex relationship.

Preferably, the power necessary for ablation with respect to the linear scan speed is defined as:

Pₜₕ=a.e^{bS}

where:

Pₜₕ is the power (W) at which the ablation threshold is reached;

S is the linear scan speed (mms⁻¹); and

a and b are constants related to the repetition rate, wherein a is measured in W⁻¹ and b in s.mm⁻¹.

In a preferred embodiment of the present invention, laser ablation is achieved by passing a laser spot over the ink layer twice. The first pass preferably cuts or ablates the unwanted material, and the second pass cleans the previously ablated areas. Preferably, the first pass of the laser is accomplished with a laser pulse repetition rate of approximately 10 kHz and a linear scanning speed of approximately 0.4 ms⁻¹. Preferably also, the second pass of the laser is achieved at a laser pulse repetition rate of approximately 20 kHz and a linear scanning speed of around 0.4 ms⁻¹.

According to a third aspect of the present invention, there is provided a method of forming conductive tracks on a substrate, the method comprising the steps of:

coating a substrate with conductive ink to create a conductive ink layer;

curing said conductive ink layer; and

ablating a portion of the cured ink layer from the substrate using a laser to define tracks of cured ink.

Preferably, the method according to the third aspect is particularly adapted for use in the production of hybrid circuits.

Conveniently, in hybrid circuit manufacture, laser ablation is achieved with a first laser pass wherein the material is ablated with a laser pulse repetition rate of 30 kHz at a linear scanning speed of 0.4 m/s, and a second laser pass wherein previously ablated areas are cleaned, which preferably is achieved with a laser pulse repetition rate of 40 kHz at 0.4 m/s linear scanning speed.

Preferably, hybrid conductive ink is cured at a temperature of around 850° C. for around 10 minutes when gold particles are present. Preferably also, in PCB manufacturing where ink comprising copper particles is used, for example, curing is achieved at a temperature of around 195° C. Typically, PCB conductive ink is cured in an oven which is ramped up to 195° C. over a period of 30 minutes, and the temperature is maintained for around 15 minutes. Preferably, the ink, once cured, is allowed to cool to ambient temperatures over approximately 12 minutes in a nitrogen atmosphere.

According to a fourth aspect of the present invention, there is provided a method of forming multiple layers of conductive tracks on a substrate, the method comprising the steps of:

coating a substrate with conductive ink to create a first conductive ink layer;

ablating a portion of the first conductive ink layer from the substrate using a laser to define a first layer of tracks of conductive ink;

curing said first layer of tracks of conductive ink;

coating the substrate incorporating said cured first layer of tracks of conductive ink with dielectric ink to create a dielectric ink layer;

ablating a portion of the dielectric ink layer using a laser to define apertures exposing portions of the cured conductive tracks of ink upon which the dielectric ink is coated;

curing said dielectric ink layer;

coating said cured dielectric ink layer with conductive ink to form a second conductive ink layer, portions of which second conductive ink layer filling said apertures in the cured dielectric layer and contacting said exposed portions of the cured conductive tracks of ink;

ablating a portion of the second ink layer from the cured dielectric ink layer using a laser to define a second layer of tracks of conductive ink; and

curing said second layer of tracks of conductive ink.

The above steps may be repeated as necessary in order to produce the required circuit. In particular, a number of layers of dielectric material may be coated in order to increase electrical insulation between conductive track layers.

Thus, a multi-layer circuit may be formed wherein adjacent layers of conductive tracks may be in direct electrical communication via apertures defined in a dielectric layer separating said adjacent conductive tracks. The apertures defined in the dielectric layer are commonly termed vias.

Consequently, a chosen circuit topography may be sequentially produced by precise forming of conductive tracks and accurate location of the vias in the dielectric ink layer which separates adjacent conductive track layers.

Preferably, the dielectric ink used in PCB manufacture is a green overglaze, and in hybrid circuit manufacture the dielectric ink is a green or blue overglaze.

Conveniently, when the dielectric ink layer is ablated, the underlying cured conductive tracks act as a “stopper” layer, preventing the laser ablating beyond the required depth because the cured ink does not absorb sufficient energy of the laser at the operating wavelength to exceed the ablation threshold of the cured ink. Similarly, the depth of ablation of the second conductive ink layer is limited to the level of the underlying cured dielectric layer which acts as a stopper layer.

Advantageously, the ink layers may be dried before ablation in order to prevent slumping or smearing of the ink, which usually occurs with wet ink, particularly wet ink having a high solvent content and corresponding low viscosity.

The ink layers may be pre-dried in ambient air conditions or alternatively in an oven which, as noted hereinbefore, produces a more uniform and consistent finish which results in improved curing post ablation.

Preferably, and particularly in PCB manufacture, the conductive ink is dried in an oven at a temperature of around 100° C. to 150° C. for around 10 to 15 minutes.

Preferably, in PCB production, when the ink is initially coated onto the substrate, an ink layer having a thickness of approximately 75 to 100 microns is produced. When the ink layer is dried, preferably the thickness reduces to approximately 60 to 90 microns due to the evaporation of the solvent from the paste.

Conveniently, in hybrid circuit manufacture, the conductive ink is dried in an oven at a temperature of around 150° C. for approximately 10 minutes. Additionally, the hybrid dielectric ink layer may be dried in an oven at 150° C. for 10 to 20 minutes.

Preferably also, in hybrid circuit manufacture, when the conductive ink is initially coated onto the substrate, an ink layer having a thickness of approximately 16 microns is produced. When the ink layer is dried, preferably the thickness reduces to approximately 9 to 12 microns. Additionally, when the hybrid dielectric is initially coated, an ink layer having a thickness of around 20 to 30 microns thick is produced which reduces to around 15 to 20 microns thick after drying.

Advantageously, PCB conductive ink is cured in an oven which is ramped up to 195° C. over a period of 30 minutes, and the temperature is maintained for around 15 minutes. Preferably, the conductive ink, once cured, is allowed to cool to ambient temperatures over approximately 12 minutes in a nitrogen atmosphere.

Conveniently, in PCB manufacture, the dielectric ink is initially UV cured under a UV lamp at a wavelength of 340 nm receiving 400 to 600 mJ/CM². Subsequently, the dielectric PCB ink is further cured in an oven at a temperature of around 150° C. for a period of approximately 30 minutes.

In a preferred embodiment, hybrid conductive ink and dielectric ink is cured in an oven at a temperature of around 850° C. for around 10 minutes.

Preferably, the dielectric and conductive ink layers are ablated by use of a pulsed laser such as a Q-switched solid state laser such as a Nd³⁺:YAG laser which produces a short energy burst of a very high intensity.

In a preferred embodiment of the present invention, laser ablation is achieved by passing a laser spot over the target ink twice. The first pass preferably cuts or ablates the unwanted material, and the second pass cleans the previously ablated areas.

Preferably, in PCB production, the dried conductor ink layer coated on the substrate is ablated with a first laser pass at a pulse repetition rate of 10 kHz at 0.4 m/s linear scanning speed and a second laser pass at a pulse repetition rate of 20 kHz at 0.4 m/s.

Furthermore, for hybrid circuit manufacture, a layer of dried dielectric material coated on a layer of cured conductor material is ablated with first and second laser passes with a pulse repetition rate of 70 kHz at a linear scanning speed of 0.4 m/s.

According to a fifth aspect of the present invention, there is provided a method of forming multiple layers of conductive tracks on a substrate, the method comprising the steps of:

coating a substrate with conductive ink to create a first conductive ink layer;

ablating a portion of the first conductive ink layer from the substrate using a laser to define a first layer of tracks of conductive ink;

curing said first layer of tracks of conductive ink;

coating the substrate incorporating said cured first layer of tracks of conductive ink with dielectric ink to create a dielectric ink layer;

curing said dielectric ink layer;

ablating a portion of the cured dielectric ink layer using a laser to define apertures exposing portions of the cured conductive tracks of ink upon which the cured dielectric ink layer is coated;

coating said cured dielectric ink layer with conductive ink to form a second conductive ink layer, portions of which second conductive ink layer filling said apertures in the cured dielectric layer and contacting said exposed portions of the cured conductive tracks of ink;

ablating a portion of the second conductive ink layer from the cured dielectric ink layer using a laser to define a second layer of tracks of conductive ink; and

curing said second layer of tracks of conductive ink.

The above steps may be repeated as necessary in order to produce the required circuit. In particular, a number of layers of dielectric material may be coated in order to increase electrical insulation between conductive track layers.

Preferably, the method according to the fifth aspect is particularly adapted for use in the production of multi-layer PCBs.

Advantageously, the conductive ink layers may be dried before ablation in order to prevent slumping or smearing of the ink, which usually occurs with wet ink, particularly wet ink having a high solvent content and corresponding low viscosity.

Preferably, and particularly in PCB manufacture, the conductive ink is dried in an oven at a temperature of around 100° C. to 150° C. for around 10 to 15 minutes.

Conveniently, in hybrid circuit manufacture, the conductive ink is dried in an oven at a temperature of around 150° C. for approximately 10 minutes. Advantageously, PCB conductive ink is cured in an oven which is ramped up to 195° C. over a period of 30 minutes, and the temperature is maintained for around 15 minutes. Preferably, the conductive ink, once cured, is allowed to cool to ambient temperatures over approximately 12 minutes in a nitrogen atmosphere.

Conveniently, in PCB manufacture, the dielectric ink is initially UV cured under a UV lamp at a wavelength of 340 nm receiving 400 to 600 mJ/cm². Subsequently, the dielectric PCB ink is further cured in an oven at a temperature of around 150° C. for a period of approximately 30 minutes.

In a preferred embodiment, hybrid conductive ink and dielectric ink is cured in an oven at a temperature of around 850° C. for around 10 minutes.

Preferably, the dielectric and conductive ink layers are ablated by use of a pulsed laser such as a Q-switched solid state laser such as a Nd³⁺:YAG laser which produces a short energy burst of a very high intensity.

In a preferred embodiment of the present invention, laser ablation is achieved by passing a laser spot over the target ink twice. The first pass preferably cuts or ablates the unwanted material, and the second pass cleans the previously ablated areas.

Preferably, in PCB production, the dried conductor ink layer coated on the substrate is ablated with a first laser pass at a pulse repetition rate of 10 kHz at 0.4 m/s linear scanning speed and a second laser pass at a pulse repetition rate of 20 kHz at 0.4 m/s.

Preferably also, in PCB manufacture, a cured layer of dielectric material is ablated with a first and second laser pass at a pulse repetition rate of 70 kHz at 0.5 m/s.

According to a sixth aspect of the present invention, there is provided a method of forming multiple layers of conductive tracks on a substrate, the method comprising the steps of:

coating a substrate with conductive ink to create a first conductive ink layer;

curing said first conductive ink layer;

ablating a portion of the cured first conductive ink layer from the substrate using a laser to define a cured first layer of tracks of conductive ink;

coating the substrate incorporating said cured first layer of tracks of conductive ink with dielectric ink to create a dielectric ink layer;

ablating a portion of the dielectric ink layer using a laser to define apertures exposing portions of the cured first layer of tracks of conductive ink upon which the dielectric ink is coated;

curing said dielectric ink layer;

coating said cured dielectric ink layer with conductive ink to form a second conductive ink layer, portions of which second conductive ink layer filling said apertures in the cured dielectric layer and contacting said exposed portions of the cured first layer of tracks of conductive ink;

curing said second conductive ink layer; and

ablating a portion of the cured second conductive ink layer from the cured dielectric ink layer using a laser to define a cured second layer of tracks of conductive ink.

The above steps may be repeated as necessary in order to produce the required circuit. In particular, a number of layers of dielectric material may be coated in order to increase electrical insulation between conductive track layers.

Preferably, the method according to the sixth aspect is particularly adapted for use in the production of hybrid circuits.

Advantageously, the dielectric ink is dried before ablating in order to prevent slumping of the ink. In a preferred embodiment, the dielectric ink used in the production of hybrid circuits is dried in an oven at a temperature of 150° C. for approximately 10 minutes.

In a preferred embodiment, hybrid conductive ink and dielectric ink is cured in an oven at a temperature of around 850° C. for around 10 minutes.

Preferably, the dielectric and conductive ink layers are ablated by use of a pulsed laser such as a Q-switched solid state laser such as a Nd³⁺:YAG laser which produces a short energy burst of a very high intensity.

In a preferred embodiment of the present invention, laser ablation is achieved by passing a laser spot over the target ink twice. The first pass preferably cuts or ablates the unwanted material, and the second pass cleans the previously ablated areas.

For hybrid circuit manufacture, a layer of cured conductor on a ceramic substrate is preferably ablated with first and second laser pass parameters of 30 kHz and 40 kHz respectively, both at a linear scanning speed of 0.4 m/s. On the other hand, for a layer of cured conductor coated on a layer of cured dielectric material, the first and second laser ablation parameters are preferably 30 kHz pulse repetition rate at 0.4 m/s linear scanning speed.

Furthermore, for hybrid circuit manufacture, a layer of dried dielectric material coated on a layer of cured conductor material is ablated with first and second laser passes with a pulse repetition rate of 70 kHz at a linear scanning speed of 0.4 m/s.

According to a seventh aspect of the present invention there is provided an apparatus for use in a method of forming conductive tracks on a substrate, the apparatus comprising:

a housing;

a laser;

means for locating a substrate having a conductive ink layer in the housing;

means for moving the laser relative to the substrate to ablate a portion of the conductive ink layer from the substrate to define tracks of ink; and

means for curing said tracks of ink.

The laser may be a continuous wave (CW) laser such as a diode or a CO₂ laser which produces long, low peak power pulses.

Preferably, the laser is a pulsed laser such as a Q-switched solid state laser which produces discrete energy pulses having high peak powers. The laser may be, for example, a Nd³⁺:YAG laser which produces a short energy burst of a very high intensity.

Preferably, the apparatus further comprises means for coating the substrate with a conductive ink to create the conductive ink layer. The coating means may be an ink screening apparatus, for example.

Preferably, the curing means is an oven such as a convection oven, conveyor type oven, vapour phase oven or infra-red oven, for example.

Alternatively, or additionally, the curing means may be a UV lamp.

Preferably, the apparatus further comprises:

means for coating a substrate incorporating cured tracks of ink with a dielectric ink layer;

means for moving the laser relative to the substrate to ablate a portion of the dielectric ink layer from the substrate to define apertures in the dielectric ink layer and expose portions of the cured tracks of ink; and

means for curing said dielectric ink layer.

Advantageously, the apparatus further comprises:

means for coating a substrate incorporating at least one layer of cured tracks of conductive ink and at least one dielectric ink layer with a conductive ink to create a further conductive ink layer;

means for moving the laser relative to the substrate to ablate a portion of the further conductive ink layer to define a further layer of tracks of conductive ink; and

means for curing said further layer of tracks of conductive ink.

These and other aspects of the present invention will now be described, by way of example only, with reference to the accompanying drawings in which:

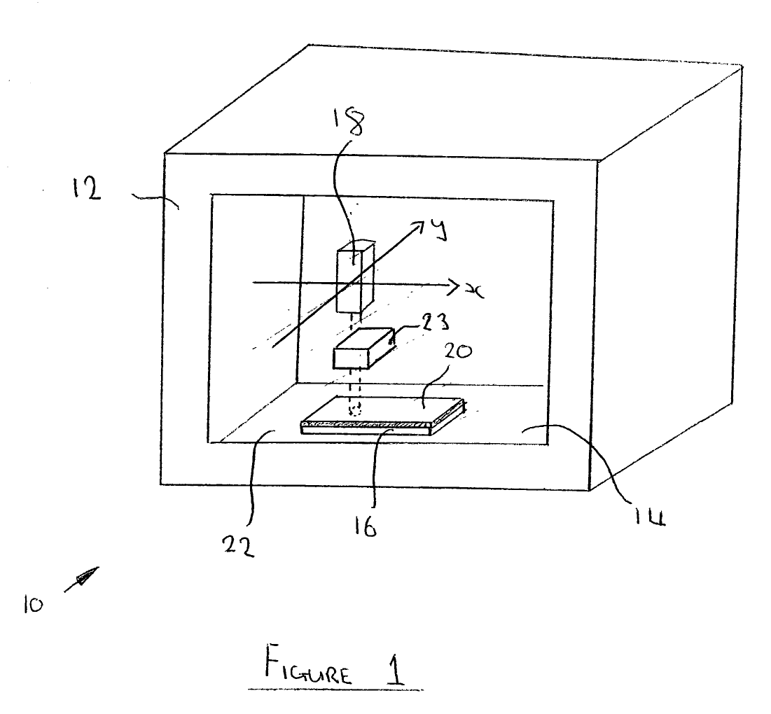

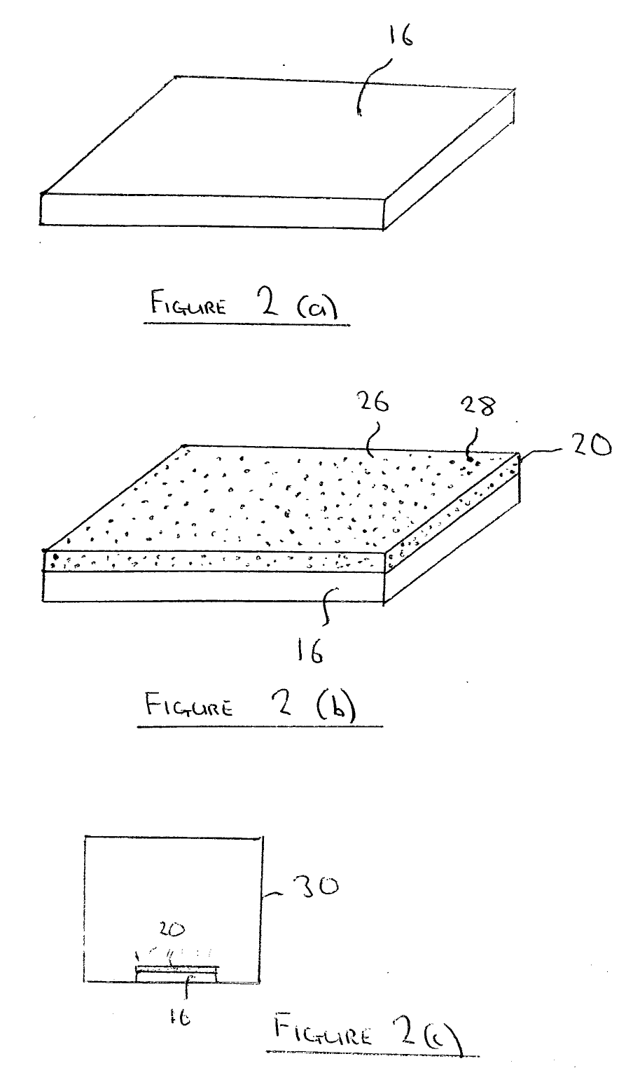

FIG. 1 is a perspective view of an apparatus for ablating ink from the surface of a substrate in accordance with one embodiment of the present invention;

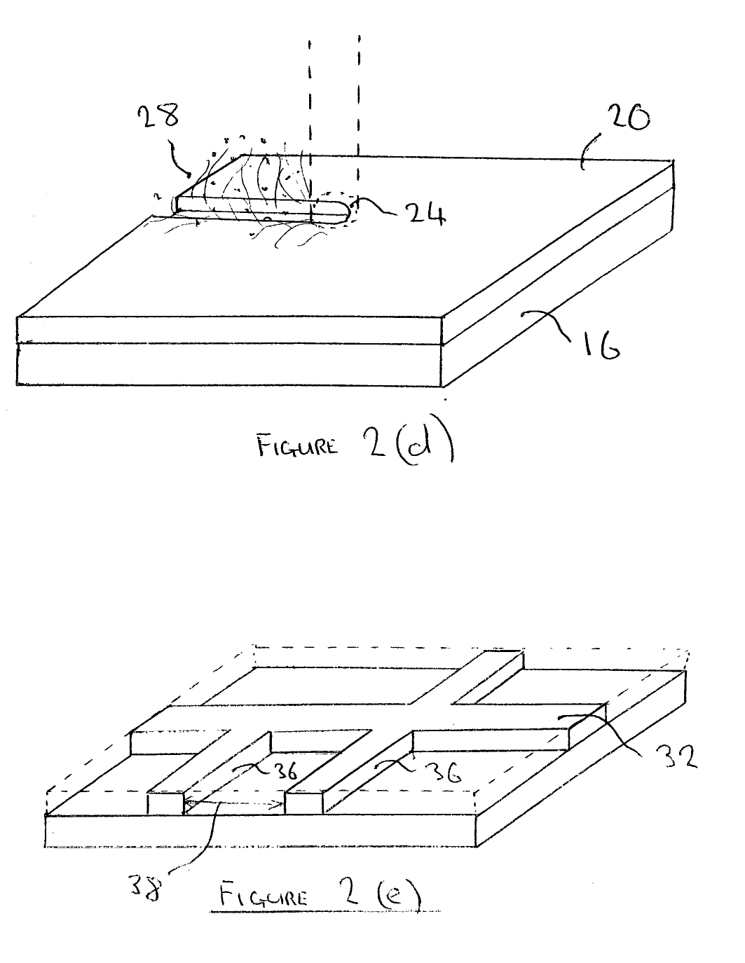

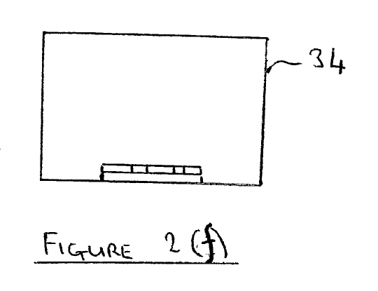

FIGS. 2(a)-(f) represent various steps in the process of forming conductive tracks on a substrate;

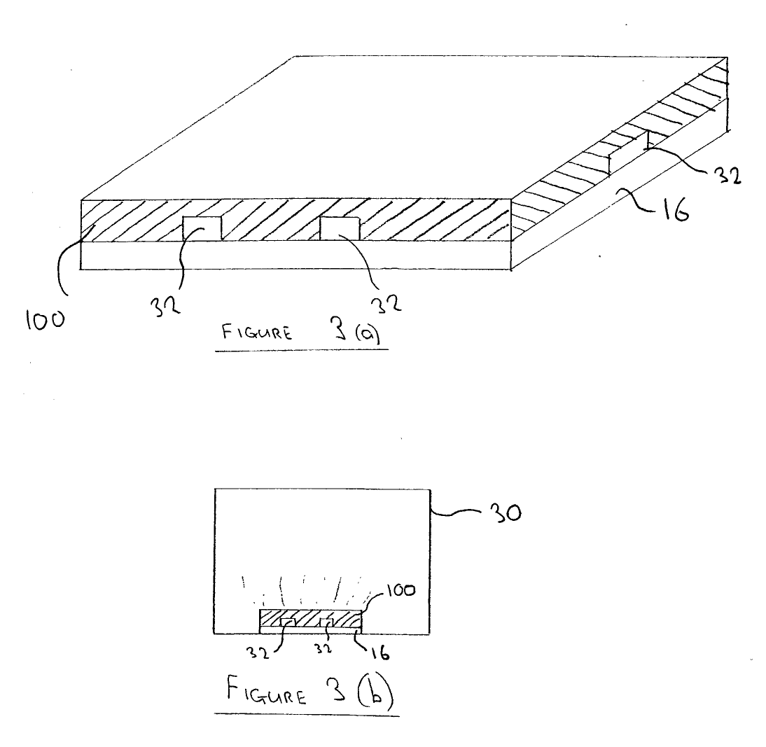

FIGS. 3(a)-(j) represents various steps in the process of forming multiple-layers of conductive tracks on a substrate;

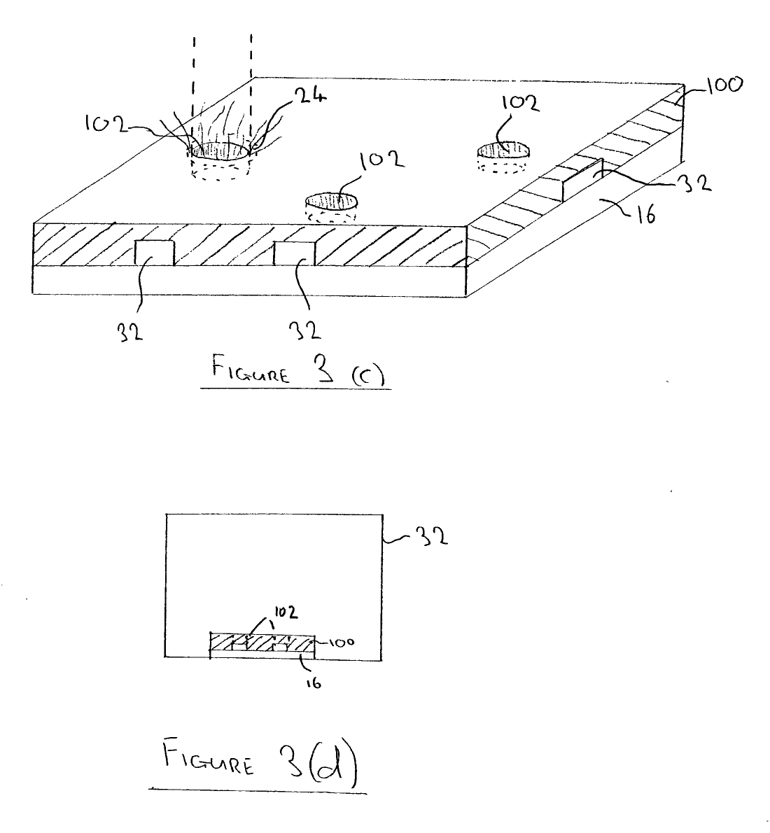

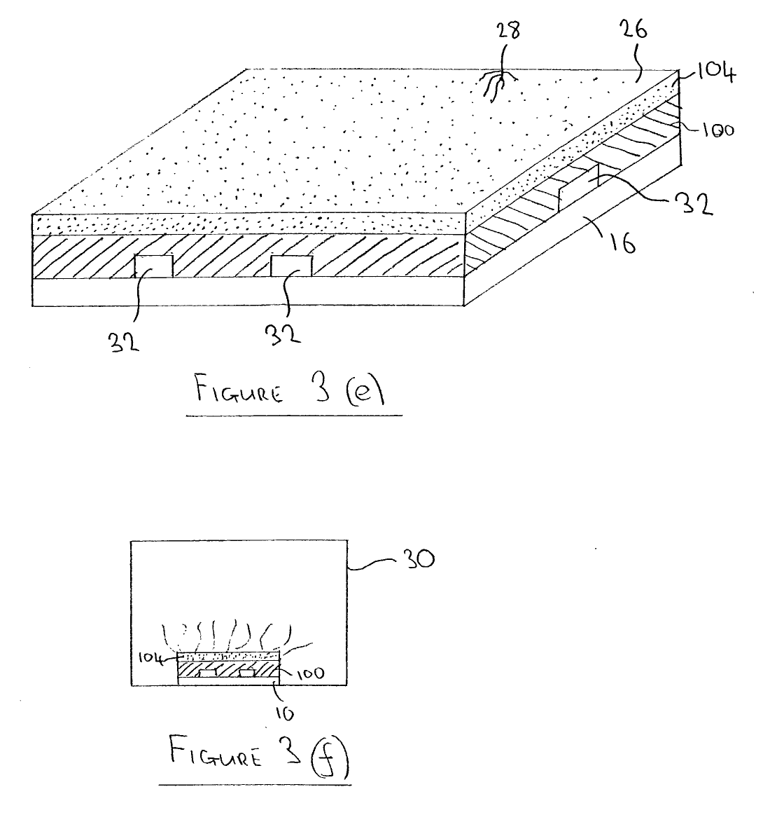

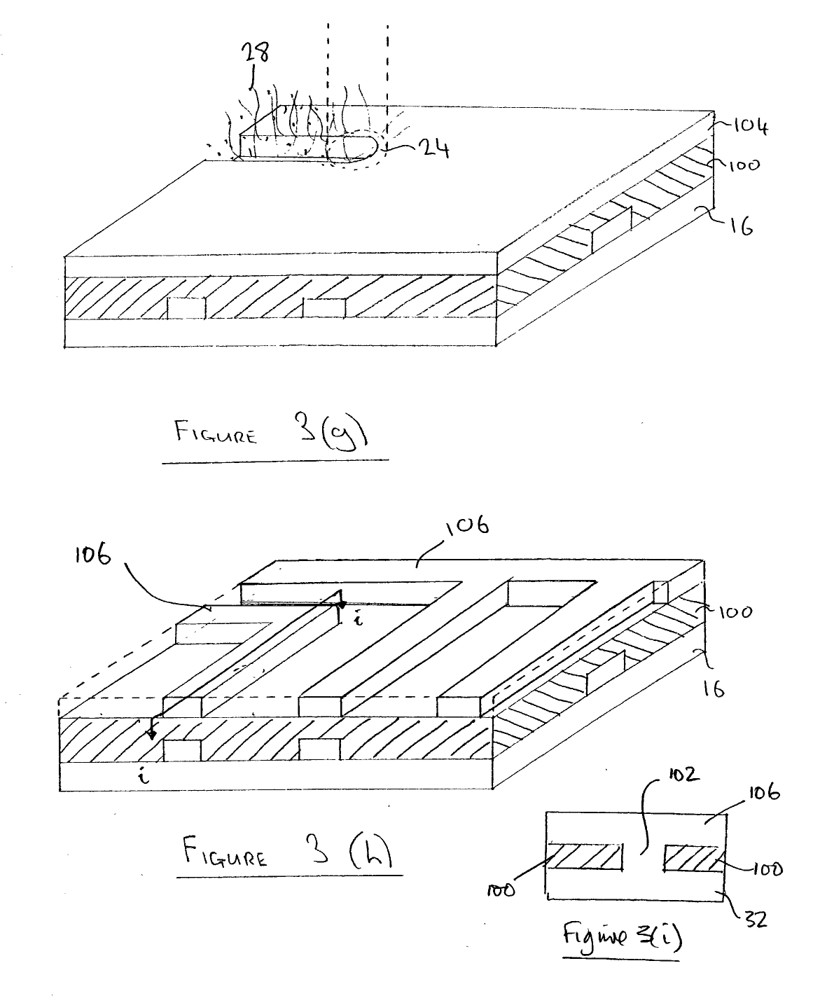

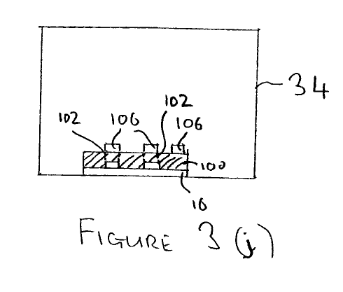

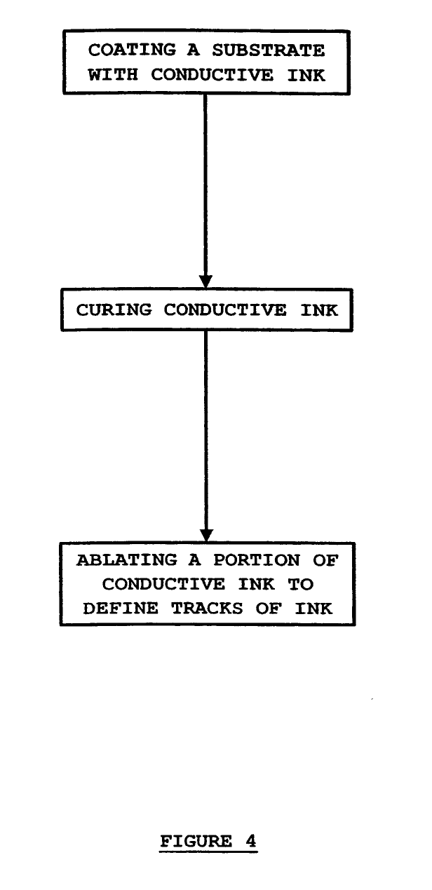

FIGS. 4-6 show flow charts representing variations in the steps shown in FIGS. 2 and 3;

FIG. 7 shows a laser spot and its corresponding intensity profile, shown in graphical form;

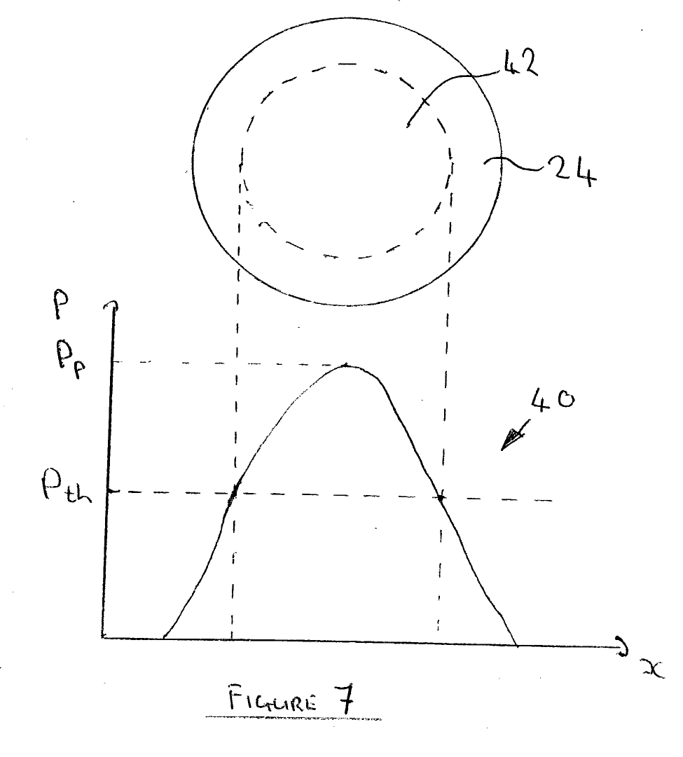

FIG. 8 is a graphical representation of the transmission spectra of an ink used for forming conductive tracks on a substrate;

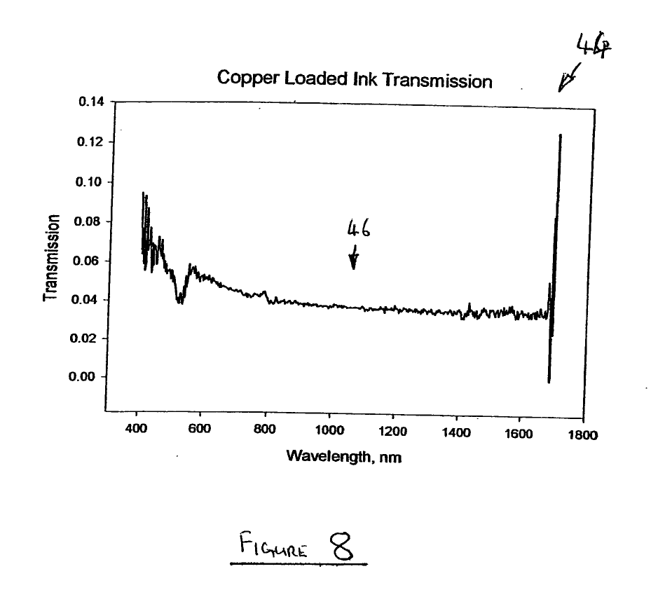

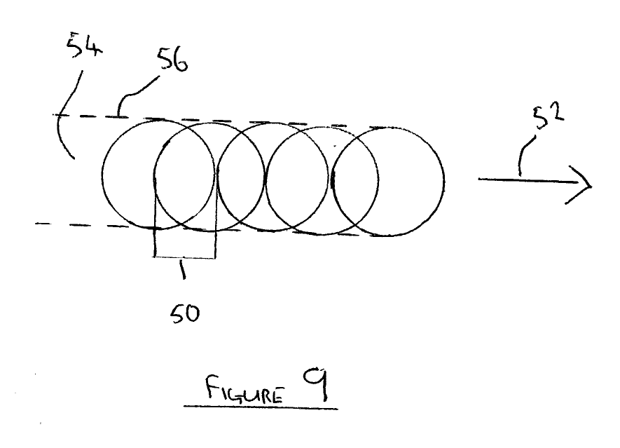

FIG. 9 shows the progression of a laser spot to ablate a channel in an ink layer; and

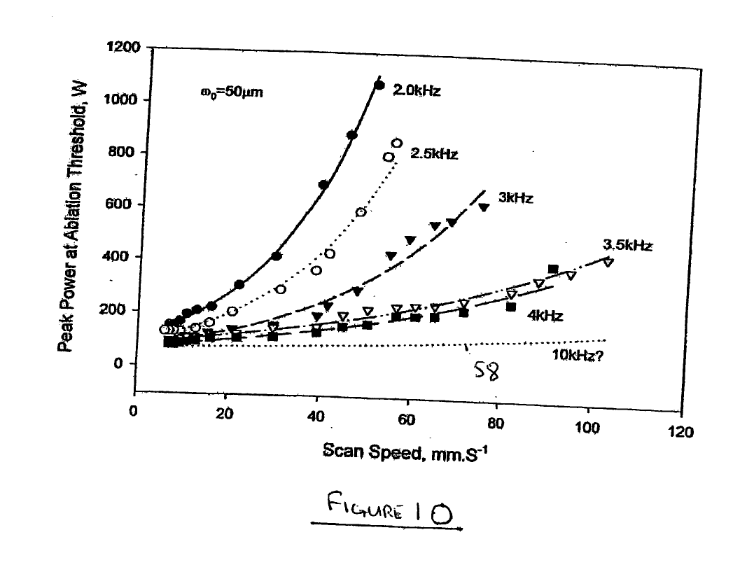

FIG. 10 shows a graph of the required ablation threshold power as a function of the linear scan speed for a number of pulse repetition rates.

Reference is first made to FIG. 1 in which there is shown an apparatus for ablating ink from the surface of a substrate. The apparatus, generally indicated by reference numeral 10, comprises a housing 12, a support surface 14 for a substrate 16, a pulsed laser 18 for ablating ink 20 from the surface of the substrate 16, and a safety cover 22. The laser 18 is moveable at least in both the x and y directions, indicated in FIG. 1, such that the laser 18 is capable of manoeuvring a laser spot 24 over the entire surface area of the substrate 16. The pulsed laser 18 is a Q-switched laser which produces discrete energy pulses having high peak powers and therefore accurately ablates the target ink 20 almost instantaneously without allowing sufficient time for thermal energy to be conducted into the surrounding area to induce burning. The apparatus 10 also comprises optical elements, generally indicated by reference numeral 23, which are used to focus and direct the laser beam, for example.

Various steps in a process of forming conductive tracks on a substrate 16 in accordance with one aspect of the present invention will now be described with reference to FIGS. 2(a)-(f). Referring initially to FIG. 2(a), there is shown a substrate 16, such as an alumina substrate or FR4 board which are commonly used in the production of Printed Circuit Boards (PCBs) or hybrid circuits. The substrate 16 is coated with an ink layer 20, as shown in FIG. 2(b), by a screening process, for example. The ink 20 comprises a paste 26 loaded with conductive particles 28 such as gold particles for the production of hybrid circuits or copper particles for the production of PCBS, for example. The paste also comprises a solvent, and fluxes and polymers, as required. The solvent can be used to obtain the required wetness or viscosity of the paste; that is, a higher solvent content will produce a lower viscosity and a wetter paste.

Once the ink 20 is coated on the substrate 16, the ink is dried in an oven 30, as shown in FIG. 2(c). Drying the ink 20 does not involve curing but merely evaporating the solvent from the paste 26 to leave the ink layer in a substantially solid state. Drying the ink before the ablation process prevents slumping of the ink and allows for a more uniform and consistent finish which results in improved curing. PCB conductive ink is dried in an oven at a temperature of around 100° C. to 150° C. for around 10 to 15 minutes. Hybrid ink is dried at a temperature of around 150° C. for approximately 10 minutes.

The subsequent step involves locating the substrate 16, coated with ink 20, in the housing 12 of the apparatus 10 shown in FIG. 1. A laser spot 24 is then focussed on the ink layer 20, as shown in FIG. 2(d), which rapidly superheats the ink 20 causing vaporisation of the solvent/fluxes/polymers and expulsion of the conductive particles 28 from the substrate surface. The energy required for the vaporisation of the solvent, flux and polymer components of the ink 20 is imparted to the ink 20 by absorption of the laser wavelength. It is therefore required that the laser light be of a wavelength which is readily absorbed by the ink. The selection of the required laser wavelength is discussed below, with reference to FIG. 8.

Thus, by moving the laser focal-spot 24 relative to the substrate 16 with the conductive ink layer 20, a PCB or hybrid circuit is created by removing unwanted ink. This produces a substrate 16 comprising a number of tracks 32 (FIG. 2(e)), which are cured in a curing oven 34 (FIG. 2(f)). In curing the ink tracks 32, heat is rapidly introduced thereto to achieve liquid phase sintering and polymer cross-linking. Hybrid circuit conductive ink is cured at a temperature of around 850° C. for around 10 minutes when gold particles are present. In PCB manufacturing where ink comprising copper particles is used, curing is achieved at a temperature of around 195° C. Typically, PCB conductive ink is cured in an oven which is ramped up to 195° C. over a period of 30 minutes, and the temperature is maintained for around 15 minutes. Preferably, the PCB ink, once cured, is allowed to cool to ambient temperatures over approximately 12 minutes in a nitrogen atmosphere.

It is apparent from FIGS. 2(d) and (e) that the minimum track size achievable is not dependent on the size of the laser spot 24, but on the accuracy of positioning the laser spot 24, since the laser spot only defines the gaps between the tracks 32 and the edges 36 thereof. The spot size does, however, determine the gap width 38 between the tracks 32.

The limiting factor on track size is dependent on the minimum conductive particle 28 size within the ink 20. Since the process depends upon the ejection of entire gold particles 26, it is preferred that a smaller particle size is used which provides for ultimately finer tracks 32 and smoother track edges 36. The preferred particle 28 diameter used in the ink of the present invention in the production of hybrid circuits is around 1 to 2 microns. In the production of PCBs, the preferred particle size is from 12 microns and up to 40 microns in diameter.

Additionally, the track size may be limited by the fluidity of the ink 20. An ink with a high solvent content will slump or smear to a certain degree into those areas where ink has been ablated due to the inks inherent low viscosity. It is for this reason that the solvent is evaporated from the ink, that is, dried, before the ablation process.

The process described above with reference to FIGS. 2(a) to (f) may be extended to produce multi-layer PCBs or hybrid circuits. Various steps in the process of forming multiple-layers of conducting tracks on a substrate 16 will now be described with reference to FIGS. 3(a)-(j). Referring initially to FIG. 3(a), the substrate 16 comprising a number of conductive ink tracks 32 as shown in FIG. 2(f) is coated with a dielectric ink layer 100 by a screening process, for example. Once coated with dielectric ink 100, the ink is then dried in an oven 30, as shown in FIG. 3(b). In hybrid circuit manufacture, the dielectric ink is dried at a temperature of approximately 150° C. for around 10 minutes.

Once the dielectric ink 100 is sufficiently dried, the substrate 16 is removed from the oven 30 and placed into the housing 12 of the apparatus 10 shown in FIG. 1. A laser focal-spot 24 is then focussed on the ink layer 100, as shown in FIG. 3(c), which ablates portions of the ink layer 100 to define apertures 102 exposing portions of the cured conductive tracks 32 upon which the dielectric ink layer 100 is coated. The apertures 102 formed in the dielectric ink layer 100 are commonly referred to as vias.

Once the required number of apertures or vias 102 are formed in the dielectric ink layer 100, the substrate is placed in a curing oven 34, as shown in FIG. 3(d), in order to cure said dielectric ink layer 100. In PCB manufacture, the dielectric ink is initially UV cured under a UV lamp at a wavelength of 340 nm receiving 400 to 600 mJ/cm². Subsequently, the dielectric PCB ink is further cured in an oven at a temperature of around 150° C. for a period of approximately 30 minutes. Hybrid dielectric ink is cured in an oven at a temperature of around 850° C. for around 10 minutes.

The subsequent step involves coating said cured dielectric ink layer 100 with a conductive ink to form a second conductive ink layer 104, portions of which second conductive ink layer 104 filling the apertures 102 previously formed in the cured dielectric layer 100 and contacting said exposed portions of the conductive tracks 32. The conductive ink comprises a paste 26 loaded with conductive particles 28 selected in accordance with the type of circuit being manufactured, the paste 26 also comprising a solvent, and fluxes and polymers, as required.

Once the ink layer 104 is coated on the cured dielectric layer 100, the ink is dried in an oven 30, as shown in FIG. 3(f) As previously described, drying the ink layer 104 does not involve curing but merely evaporating the solvent from the paste 26 to leave the ink layer 104 in a substantially solid state.

The subsequent step in the process, shown in FIG. 3(g), involves re-locating the substrate 16 with the previously dried second conductive ink layer 104 into the housing 12 of the apparatus 10 of FIG. 1. A laser focal-spot 24 is then focussed on the ink layer 104 which absorbs the laser wavelength, superheating the ink and causing rapid vaporisation of the solvent/fluxes/polymers and expulsion of the conductive particles 28. The laser focal-spot 24 is moved over the surface of the ink layer 104 until the required track 106 pattern is defined, as shown in FIG. 3(h).

A view through a plane indicated by arrows i-i is shown in FIG. 3(i), wherein a via 102 is clearly seen joining conductive tracks 32, 102, which are otherwise separated by the cured dielectric layer 100.

As before, the ink tracks 106 are then cured in a curing oven 34 (FIG. 3(j)).

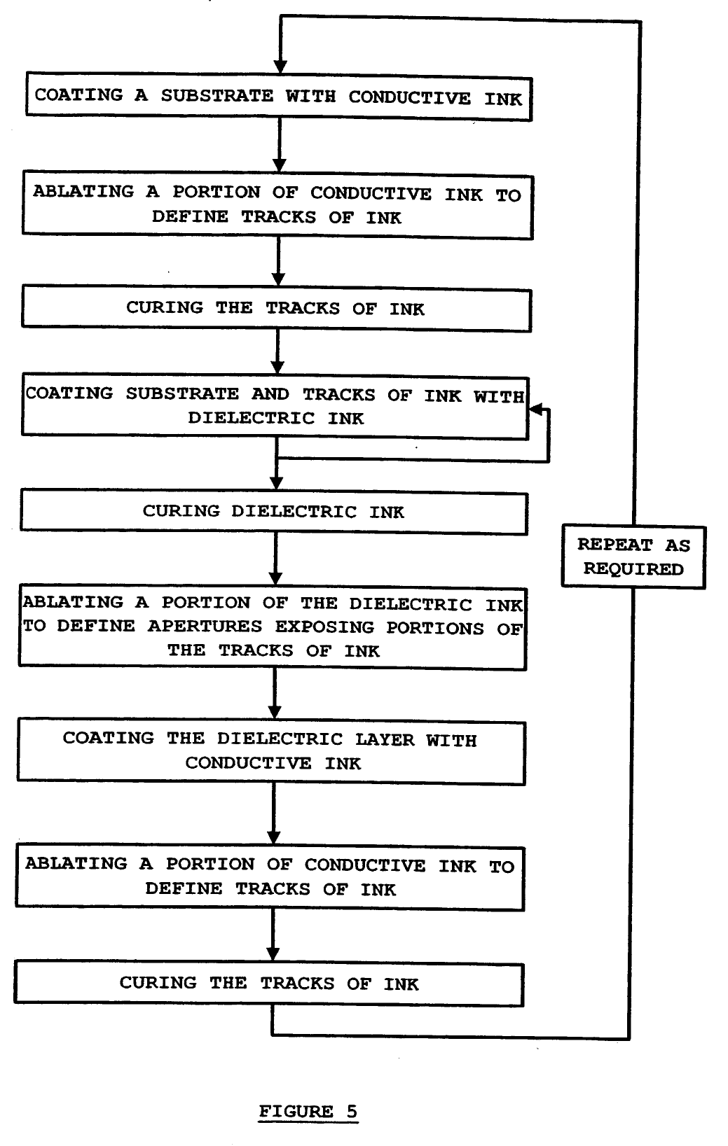

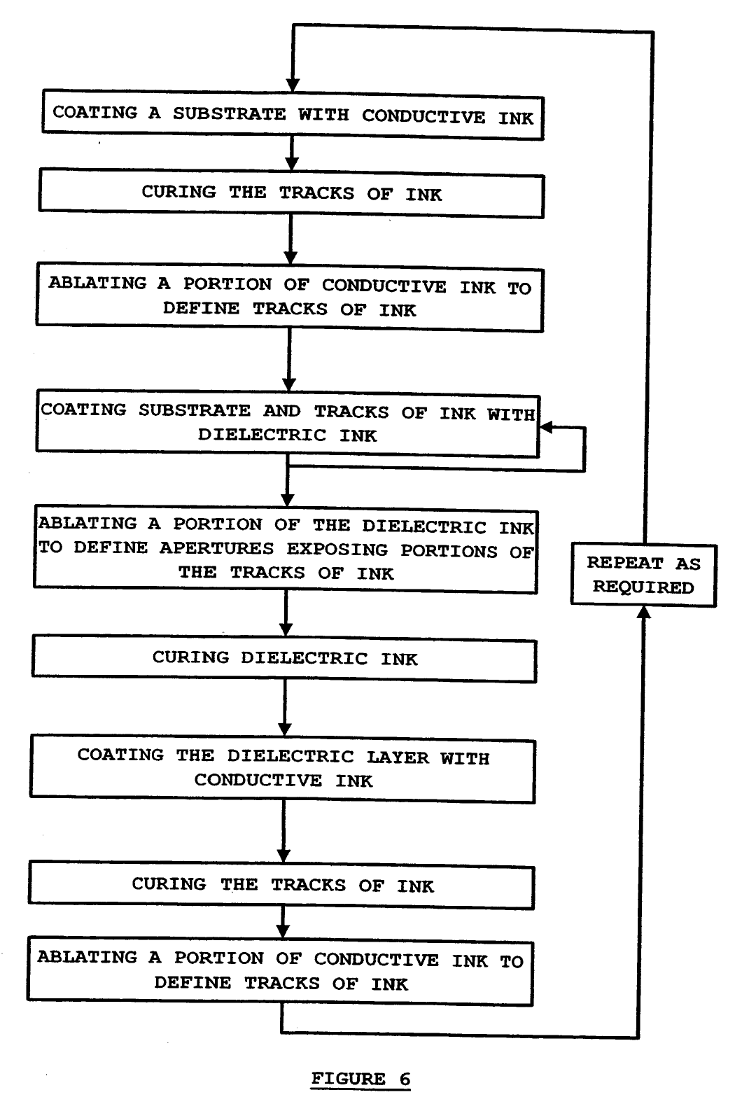

The embodiments described above with reference to FIGS. 2 and 3 are merely exemplary of aspects of the present invention. However, the particular steps noted above in the process of forming a PCB, multi-layer PCB or hybrid circuit may be rearranged as required, in accordance with the required circuit to be produced. FIGS. 4, 5 and 6 show alternative processes in accordance with alternative aspects of the present invention, the processes being represented in the form of flow diagrams. The process shown in FIG. 4 is particularly adapted for the production of single layer hybrid circuits. The process shown in FIG. 5 is particularly adapted for the production of multi-layer PCBs, and the process shown in FIG. 6 is particularly suitable for the manufacture of multiple layer hybrid circuits.

For the ink to be ablated, the power intensity of the laser spot must be in excess of the ablation threshold of the ink, wherein the ablation threshold is the minimum power intensity required to cause ablation. As it is normal for the power intensity to vary within the laser spot 24 itself, the amount of ink ablated will be determined by the effective spot size; that is, that area of the spot 24 whose intensity exceeds the ablation threshold of the conductive ink 20. This is indicated in FIG. 7 in which there is shown a laser spot 24 and its corresponding intensity profile 40, shown in graphical form.

The power intensity P of the laser spot 24 is measured across the diameter of the spot 24, and indicated on the graph is the ablation threshold intensity Pₜₕ. Laser spot sizes can be measured at full-width half maximum (FWHM), but in general, the radius or diameter is measured at the 1/e² intensity points on the Gaussian distribution. Thus, the area within the spot whose intensity exceeds Pₜₕ defines the effective spot size 42. For example, a 25 W average power Q-switched Nd:YAG laser with a spot size of 64 microns in diameter, a repetition rate (time between pulses) of 5 kHz and a pulse duration of 42 nanoseconds will produce an ablated line width of 50 microns.

It is therefore preferred to use a laser with a high quality laser beam with a Gaussian intensity profile, like that shown in FIG. 7. This allows for improved control over the effective spot size 42 by varying the power of the laser itself.

As discussed above, it is required that the laser light be of a wavelength which is readily absorbed by the ink. Referring to FIG. 8, there is shown a transmission spectra 44 of the ink 20 in its liquid state which shows that the ink exhibits a relatively flat transmission 46 across the visible and into the near infra-red regions of the spectrum. This indicates that many common lasers, such as Nd:YAG, ion, fibre and diode-lasers can be used to supply energy to the ink 20.

A typical pulsed laser has a number of parameters which may be dependent on each other, and may thus be selected or controlled in accordance with the required operation of the pulsed laser. Such parameters include:

the linear scanning speed, which defines the speed at which a laser spot travels along a target surface, measured in unit distance per unit time;

the pulse length, which defines the time length of the laser pulses;

the repetition rate, which defines the time length between laser pulses;

laser power, which defines the actual power of the laser;

peak power Pₚ (FIG. 7), which defines the maximum power level reached during a short pulse. This quantity is higher than the average power level of a Q-switched laser, for example;

the spot size, which defines the actual diameter of the laser spot 24 incident on the target surface;

the effective spot 42 size (FIG. 7), which defines the diameter of the area within the laser spot 24 whose intensity is greater than the ablation threshold Pₜₕ of the conductive ink 20; and

the pulse spacing, which defines the distance travelled by the laser focal spot 24 relative to the target between laser pulses.

A maximum pulse spacing on the target of half the effective spot size 42 (FIG. 7) is required to obtain a continuous ablated area to produce tracks 32 (FIG. 2(e)) with uniform track edges 36 (FIG. 2(e)). The maximum pulse spacing 50 is shown in FIG. 9 in which a laser spot is shown to be progressing in the direction of arrow 52 to ablate a channel 54 having walls 56. For clarity, the spot size shown is the effective spot size.

The maximum linear scan speed for a given repetition rate is the effective spot radius (effective spot size/2) multiplied by the repetition rate of the laser. For example, a 10 kHz laser beam can be used to cut a 100 micron track at 0.5 ms⁻¹, or a 200 micron track at 1 ms⁻¹. In comparison, the use of a 20 kHz beam will double these maximum speeds. However, although these are the maximum speeds attainable with a specific repetition rate, the actual speed attainable then relies on the available peak power Pₚ. The dependency of the maximum linear scan speed on the peak power Pₚ is a more complex relationship.

The relationship between the ablation threshold power with respect to the linear scan speed will now be discussed with reference to FIG. 10, in which there is shown a graph of the required ablation threshold power as a function of the linear scan speed for a number of pulse repetition rates, namely 2, 2.5, 3, 3.5 and 4 kHz. The data for the graph was taken from experimental measurements.

The general behaviour of the data curves may still be utilised for prediction and control of the required ablation threshold powers. From FIG. 10, it is immediately apparent that linear scan speed is not only dependent upon peak power, but also on laser pulse repetition rate.

From the data shown in FIG. 10, a general expression may be obtained for each curve shown in FIG. 10. Thus, the relationship between the ablation threshold power with respect to the linear scan speed may be defined by:

Pₜₕ=a.e^{bS}

where:

Pₜₕ is the power (W) at which the ablation threshold is reached;

S is the linear scan speed (mms⁻¹); and

a and b are constants related to the repetition rate, shown in Table 1 below.

a is measured in W⁻¹ and b in s.mm⁻¹.

TABLE 1

| PULSE REPETITION | | |
|---|---|---|
| RATE (kHz) | CONSTANT “a” | CONSTANT “b” |
| 2.0 | 111.2 | 4.59 |
| 2.5 | 92.01 | 3.92 |
| 3.0 | 75.4 | 2.97 |
| 3.5 | 87.75 | 1.62 |
| 40 | 73.3 | 1.7 |
| 10 “guess” | 64.7 | 0.79 |

Values for constants a and b for a pulse repetition rate of 10 kHz is shown in Table 1, and the corresponding curve 58 is shown in FIG. 10.

It should be noted that the embodiments hereinbefore described are merely exemplary and various modifications may be made thereto without departing from the scope of the present invention. For example, the ink may be pre-dried in ambient air conditions to eliminate the requirement for a drying oven. The ink may be ablated while wet which would have a lower ablation threshold and therefore require a lower laser peak power. The ink may be cured by use of a second laser by scanning a de-focussed spot over the tracks of ink formed by the ablation process. This would also provide the formation of PCBs or hybrid circuits in a single process. The ink may be ablated by passing the laser spot over the target area twice; the first to ablate the unwanted material, and the second to clean the previously ablated areas.

Additionally, the ink, when applied to the substrate, may have a relatively high viscosity sufficient to prevent, or at least minimise, the degree of slumping during ablation. This would eliminate any requirement for pre-drying. Furthermore since the ink will still contain solvent during the ablation process, i.e., solvent is not evaporated because the ink is not dried, ablation will be easier relative to that of pre-dried ink which has substantially no solvent content.

The composition of the ink may be varied, for example, to include any conductive particles such as silver, copper or carbon particles or the like, and may include solder material such as a silver material, for example.

1. A method of creating a three-dimensional structure on a surface, said method comprising the steps of:
coating a surface with ink to create an ink layer; and
ablating a portion of the ink layer from said surface using a laser to define said three-dimensional features in the remaining ink layer.

2. A method of forming conductive tracks on a substrate, the method comprising the steps of:
coating a substrate with conductive ink to create a conductive ink layer;
ablating a portion of the ink layer from the substrate using a laser to define tracks of ink; and
curing said tracks of ink.

3. A method of forming conductive tracks on a substrate as claimed in claim 2, wherein the substrate upon which the ink layer is coated is an alumina substrate.

4. A method of forming conductive tracks on a substrate as claimed in claim 2, wherein the substrate is FR4 board.

5. A method of forming conductive tracks on a substrate as claimed in claim 2, wherein the ink comprises a paste loaded with conductive particles.

6. A method of forming conductive tracks on a substrate as claimed in claim 5, wherein the conductive particles are metallic particles.

7. A method of forming conductive tracks on a substrate as claimed in claim 5, wherein the conductive particles are gold particles.

8. A method of forming conductive tracks on a substrate as claimed in claim 5, wherein the conductive particles are copper particles.

9. A method of forming conductive tracks on a substrate as claimed in claim 5, wherein the paste is loaded with non-metallic conductive particles.

10. A method of forming conductive tracks on a substrate as claimed in claim 5, wherein the conductive particles are carbon particles.

11. A method of forming conductive tracks on a substrate as claimed in claim 5, wherein the paste includes a solvent.

12. A method of forming conductive tracks on a substrate as claimed in claim 5, wherein the paste includes fluxes and polymers.

13. A method of forming conductive tracks on a substrate as claimed in claim 2, wherein the ink includes a solder material.

14. A method of forming conductive tracks on a substrate as claimed in claim 13, wherein the solder material is a silver solder material.

15. A method of forming conductive tracks on a substrate as claimed in claim 2, wherein, where the process is used in PCB manufacture, the ink used comprises copper particles having a diameter of up to 40 microns, and is coated onto a substrate having a thickness of between 0.3 mm and 1.6 mm.

16. A method of forming conductive tracks on a substrate as claimed in claim 2, wherein, where the process is used in the manufacture of hybrid circuits, the ink used comprises gold particles of 1 to 2 microns in diameter, and is coated onto a substrate.

17. A method of forming conductive tracks on a substrate as claimed in claim 2, wherein when a laser spot produced by the laser is focussed onto an ink layer deposited on a substrate, the ink is ablated down to the level of the substrate, which substrate acts as a stopper layer.

18. A method of forming conductive tracks on a substrate as claimed in claim 2, wherein the conductive ink is ablated while wet.

19. A method of forming conductive tracks on a substrate as claimed in claim 2, wherein the ink, when applied to the substrate, has a relatively high viscosity sufficient to at least minimise the degree of slumping during an ablation process.

20. A method of forming conductive tracks on a substrate as claimed in claim 2, wherein the conductive ink layer is dried before the ink is ablated to prevent slumping of the ink into ablated regions.

21. A method of forming conductive tracks on a substrate as claimed in claim 20, wherein the ink is dried in ambient air conditions.

22. A method of forming conductive tracks on a substrate as claimed in claim 20, wherein the ink is dried in an oven.

23. A method of forming conductive tracks on a substrate as claimed in claim 20, wherein, in PCB manufacture, the ink is dried in an oven at a temperature of between 100° C. to 150° C. for 10 to 15 minutes.

24. A method of forming conductive tracks on a substrate as claimed in claim 2, wherein, in PCB production, when the ink is initially coated onto the substrate, an ink layer having a thickness of 75 to 100 microns is produced.

25. A method of forming conductive tracks on a substrate as claimed in claim 20, wherein, in PCB manufacture, when the ink layer is dried, an ink layer having a thickness of 60 to 90 microns is produced.

26. A method of forming conductive tracks on a substrate as claimed in claim 20, wherein, in hybrid circuit manufacture, the ink is dried in an oven at a temperature of 150° C. for 10 minutes.

27. A method of forming conductive tracks on a substrate as claimed in claim 2, wherein, in hybrid circuit manufacture, when the ink is initially coated onto the substrate, an ink layer having a thickness of 16 microns is produced.

28. A method of forming conductive tracks on a substrate as claimed in claim 20, wherein, in hybrid circuit manufacture, when the ink layer is dried, an ink layer having a thickness of 9 to 12 microns is produced.

29. A method of forming conductive tracks on a substrate as claimed in claim 2, wherein the ink is cured in an oven.

30. A method of forming conductive tracks on a substrate as claimed in claim 2, wherein, conductive ink used in the production of hybrid circuits is cured at a temperature of around 850° C. for around 10 minutes when gold particles are present.

31. A method of forming conductive tracks on a substrate as claimed in claim 2, wherein, in PCB manufacturing where ink comprising copper particles is used, curing is achieved at a temperature of around 195° C.

32. A method of forming conductive tracks on a substrate as claimed in claim 2, wherein, in PCB manufacturing where ink comprising copper particles is used, the ink is cured in an oven in a nitrogen atmosphere which is ramped up to 195° C. over a period of 30 minutes, and the temperature is maintained for 15 minutes, and once cured, the ink is allowed to cool to ambient temperatures over 12 minutes.

33. A method of forming conductive tracks on a substrate as claimed in claim 2, wherein the ink is cured by use of a de-focussed laser spot scanned over the tracks of ink defined by the ablation process.

34. A method of forming conductive tracks on a substrate as claimed in claim 2, wherein, when cured, the thickness of the tracks of ink is 5 to 8 microns in hybrid circuit manufacture.

35. A method of forming conductive tracks on a substrate as claimed in claim 2, wherein, when cured, the thickness of the conductive tracks is 60 to 90 microns in PCB manufacture.

36. A method of forming conductive tracks on a substrate as claimed in claim 2, wherein the ink is ablated by use of a low power continuous wave (CW) laser.

37. A method of forming conductive tracks on a substrate as claimed in claim 2, wherein the ink is ablated by use of a pulsed laser.

38. A method of forming conductive tracks on a substrate as claimed in claim 2, wherein the laser is a Q-switched solid state laser.

39. A method of forming conductive tracks on a substrate as claimed in claim 2, wherein the laser is a Nd³⁺:YAG laser.

40. A method of forming conductive tracks on a substrate as claimed in claim 2, wherein the laser comprises a high quality laser beam with a Gaussian intensity profile.

41. A method of forming conductive tracks on a substrate as claimed in claim 2, wherein the laser produces a laser spot having an effective spot size smaller than the actual spot size, said effective spot size being located within the laser spot and having a power intensity greater than the ablation threshold of the ink.

42. A method of forming conductive tracks on a substrate as claimed in claim 41, wherein control over the effective spot size may be achieved by varying the power intensity of the laser.

43. A method of forming conductive tracks on a substrate as claimed in claim 2, wherein the laser produces gap widths between tracks of ink of below 75 microns.

44. A method of forming conductive tracks on a substrate as claimed in claim 2, wherein the laser produces gap widths between tracks of ink of 50 microns and below.

45. A method of forming conductive tracks on a substrate as claimed in claim 41, wherein a pulsed laser having a maximum pulse spacing of half the effective spot size is required to obtain a continuous ablated area to produce tracks with uniform track edges.

46. A method of forming conductive tracks on a substrate as claimed in claim 41, wherein the maximum linear scan speed for a given repetition rate is the effective spot radius multiplied by the repetition rate of the laser.

47. A method of forming conductive tracks on a substrate as claimed in claim 41, wherein the power necessary for ablation with respect to the linear scan speed is defined as:
Pₜₕa.e^{bS}
where:
Pₜₕ is the power (W) at which the ablation threshold is reached;
S is the linear scan speed (mms⁻¹); and
a and b are constants related to the repetition rate, wherein a is measured in W⁻¹ and b in s.mm⁻¹.

48. A method of forming conductive tracks on a substrate as claimed in claim 2, wherein laser ablation is achieved by passing a laser spot produced by the laser over the ink layer twice, the first pass to ablate a portion of the ink layer, and the second pass to clean the previously ablated ink portions.

49. A method of forming conductive tracks on a substrate as claimed in claim 48, wherein the first pass of the laser is accomplished with a laser pulse repetition rate of 10 kHz and a linear scanning speed of 0.4 ms⁻¹, and the second pass of the laser is achieved at a laser pulse repetition rate of 20 kHz and a linear scanning speed of 0.4 ms⁻¹.

50. A method of forming conductive tracks on a substrate, the method comprising the steps of:
coating a substrate with conductive ink to create a conductive ink layer;
curing said conductive ink layer; and
ablating a portion of the cured ink layer from the substrate using a laser to define tracks of cured ink.

51. A method of forming conductive tracks on a substrate as claimed in claim 50, wherein the method is particularly adapted for use in the production of hybrid circuits.

52. A method of forming conductive tracks on a substrate as claimed in claim 50, wherein, in hybrid circuit manufacture, laser ablation is achieved with a first laser pass wherein the material is ablated with a laser pulse repetition rate of 30 kHz at a linear scanning speed of 0.4 m/s, and a second laser pass wherein previously ablated areas are cleaned, which preferably is achieved with a laser pulse repetition rate of 40 kHz at 0.4 m/s linear scanning speed.

53. A method of forming multiple layers of conductive tracks on a substrate, the method comprising the steps of:
coating a substrate with conductive ink to create a first conductive ink layer;
ablating a portion of the first conductive ink layer from the substrate using a laser to define a first layer of tracks of conductive ink;
curing said first layer of tracks of conductive ink;
coating the substrate incorporating said cured first layer of tracks of conductive ink with dielectric ink to create a dielectric ink layer;
ablating a portion of the dielectric ink layer using a laser to define apertures exposing portions of the cured conductive tracks of ink upon which the dielectric ink is coated;
curing said dielectric ink layer;
coating said cured dielectric ink layer with conductive ink to form a second conductive ink layer, portions of which second conductive ink layer filling said apertures in the cured dielectric layer and contacting said exposed portions of the cured conductive tracks of ink;
ablating a portion of the second ink layer from the cured dielectric ink layer using a laser to define a second layer of tracks of conductive ink; and
curing said second layer of tracks of conductive ink.

54. A method of forming multiple layers of conductive tracks on a substrate as claimed in claim 53, wherein the steps are repeated as necessary in order to produce the required circuit.

55. A method of forming multiple layers of conductive tracks on a substrate as claimed in claim 53, wherein dielectric ink used in PCB manufacture is a green overglaze, and dielectric ink used in hybrid circuit manufacture is a green or blue overglaze.

56. A method of forming multiple layers of conductive tracks on a substrate as claimed in claim 53, wherein, when the dielectric ink layer is ablated, the underlying cured conductive tracks act as a stopper layer.

57. A method of forming multiple layers of conductive tracks on a substrate as claimed in claim 53, wherein the depth of ablation of the second conductive ink layer is limited to the level of the underlying cured dielectric layer which acts as a stopper layer.

58. A method of forming multiple layers of conductive tracks on a substrate as claimed in claim 53, wherein the ink layers are dried before ablation.

59. A method of forming multiple layers of conductive tracks on a substrate as claimed in claim 58, wherein a dielectric ink layer used in the production of hybrid circuits is dried in an oven at 150° C. for 10 to 20 minutes.

60. A method of forming multiple layers of conductive tracks on a substrate as claimed in claim 58, wherein, when dielectric ink for use in the production of hybrid circuits is initially coated, a dielectric ink layer having a thickness of 20 to 30 microns thick is produced which reduces to 15 to 20 microns thick after drying.

61. A method of forming multiple layers of conductive tracks on a substrate as claimed in claim 53, wherein, in PCB manufacture, the dielectric ink is initially UV cured under a UV lamp at a wavelength of 340 nm receiving 400 to 600 mJ/cm², and subsequently, the dielectric PCB ink is further cured in an oven at a temperature of 150° C. for a period of 30 minutes.

62. A method of forming multiple layers of conductive tracks on a substrate as claimed in claim 53, wherein, in hybrid circuit manufacture, conductive ink and dielectric ink is cured in an oven at a temperature of 850° C. for 10 minutes.

63. A method of forming multiple layers of conductive tracks on a substrate as claimed in claim 53, wherein laser ablation is achieved by passing a laser spot produced by the laser over the ink layer twice, the first pass to ablate a portion of the ink layer, and the second pass to clean the previously ablated ink portions.

64. A method of forming multiple layers of conductive tracks on a substrate as claimed in claim 63, wherein, in PCB production, the conductive ink layer coated on the substrate is ablated with a first laser pass at a pulse repetition rate of 10 kHz at 0.4 m/s linear scanning speed, and a second laser pass at a pulse repetition rate of 20 kHz at 0.4 m/s.

65. A method of forming multiple layers of conductive tracks on a substrate as claimed in claim 63, wherein, in hybrid circuit manufacture, a layer of dried dielectric material coated on a layer of cured conductor material is ablated with first and second laser passes with a pulse repetition rate of 70 kHz at a linear scanning speed of 0.4 m/s.

66. A method of forming multiple layers of conductive tracks on a substrate, the method comprising the steps of:
coating a substrate with conductive ink to create a first conductive ink layer;
ablating a portion of the first conductive ink layer from the substrate using a laser to define a first layer of tracks of conductive ink;
curing said first layer of tracks of conductive ink;
coating the substrate incorporating said cured first layer of tracks of conductive ink with dielectric ink to create a dielectric ink layer;
curing said dielectric ink layer;
ablating a portion of the cured dielectric ink layer using a laser to define apertures exposing portions of the cured conductive tracks of ink upon which the cured dielectric ink layer is coated;
coating said cured dielectric ink layer with conductive ink to form a second conductive ink layer, portions of which second conductive ink layer filling said apertures in the cured dielectric layer and contacting said exposed portions of the cured conductive tracks of ink;
ablating a portion of the second conductive ink layer from the cured dielectric ink layer using a laser to define a second layer of tracks of conductive ink; and
curing said second layer of tracks of conductive ink.

67. A method of forming multiple layers of conductive tracks on a substrate as claimed in claim 66, wherein the steps are repeated as necessary in order to produce the required circuit.

68. A method of forming multiple layers of conductive tracks on a substrate as claimed in claim 66, wherein the method is particularly adapted for use in the production of multi-layer PCBs.

69. A method of forming multiple layers of conductive tracks on a substrate as claimed in claim 66, wherein the conductive ink layers are dried before ablation.

70. A method of forming multiple layers of conductive tracks on a substrate as claimed in claim 66, wherein laser ablation is achieved by passing a laser spot over the ink layer twice, the first pass to ablate a portion of the ink layer, and the second pass to clean the previously ablated ink portions.

71. A method of forming multiple layers of conductive tracks on a substrate as claimed in claim 70, wherein, in PCB production, the dried conductor ink layer coated on the substrate is ablated with a first laser pass at a pulse repetition rate of 10 kHz at 0.4 m/s linear scanning speed, and a second laser pass at a pulse repetition rate of 20 kHz at 0.4 m/s.

72. A method of forming multiple layers of conductive tracks on a substrate as claimed in claim 70, wherein, in PCB manufacture, a cured layer of dielectric material is ablated with a first and second laser pass at a pulse repetition rate of 70 kHz at 0.5 m/s.

73. A method of forming multiple layers of conductive tracks on a substrate, the method comprising the steps of:
coating a substrate with conductive ink to create a first conductive ink layer;
curing said first conductive ink layer;
ablating a portion of the cured first conductive ink layer from the substrate using a laser to define a cured first layer of tracks of conductive ink;
coating the substrate incorporating said cured first layer of tracks of conductive ink with dielectric ink to create a dielectric ink layer;
ablating a portion of the dielectric ink layer using a laser to define apertures exposing portions of the cured first layer of tracks of conductive ink upon which the dielectric ink is coated;
curing said dielectric ink layer;
coating said cured dielectric ink layer with conductive ink to form a second conductive ink layer, portions of which second conductive ink layer filling said apertures in the cured dielectric layer and contacting said exposed portions of the cured first layer of tracks of conductive ink;
curing said second conductive ink layer; and
ablating a portion of the cured second conductive ink layer from the cured dielectric ink layer using a laser to define a cured second layer of tracks of conductive ink.

74. A method of forming multiple layers of conductive tracks on a substrate as claimed in claim 73, wherein the steps are repeated as necessary in order to produce the required circuit.

75. A method of forming multiple layers of conductive tracks on a substrate as claimed in claim 73, wherein the method is particularly adapted for use in the production of hybrid circuits.

76. A method of forming multiple layers of conductive tracks on a substrate as claimed in claim 73, wherein the dielectric ink layer is dried before ablating.

77. A method of forming multiple layers of conductive tracks on a substrate as claimed in claim 73, wherein laser ablation is achieved by passing a laser spot over the ink layer twice, the first pass to ablate a portion of the ink layer, and the second pass to clean the previously ablated ink portions.

78. A method of forming multiple layers of conductive tracks on a substrate as claimed in claim 77, wherein, in hybrid circuit manufacture, a layer of cured conductive ink on a ceramic substrate is ablated with first and second laser pass parameters of 30 kHz and 40 kHz respectively, both at a linear scanning speed of 0.4 m/s.

79. A method of forming multiple layers of conductive tracks on a substrate as claimed in claim 77, wherein, in hybrid circuit manufacture, a layer of cured conductor coated on a layer of cured dielectric material is ablated with first and second laser ablation parameters of 30 kHz pulse repetition rate at 0.4 m/s linear scanning speed.

80. A method of forming multiple layers of conductive tracks on a substrate as claimed in claim 77, wherein, in hybrid circuit manufacture, a layer of dried dielectric material coated on a layer of cured conductor material is ablated with first and second laser passes with a pulse repetition rate of 70 kHz at a linear scanning speed of 0.4 m/s.

81. An apparatus for use in a method of forming conductive tracks on a substrate, the apparatus comprising:
a housing;
a laser;
means for locating a substrate having a conductive ink layer in the housing;
means for moving the laser relative to the substrate to ablate a portion of the conductive ink layer from the substrate to define tracks of ink; and
means for curing said tracks of ink.

82. An apparatus for use in a method of forming conductive tracks on a substrate as claimed in claim 81, wherein the laser is a low power continuous wave (CW) laser.

83. An apparatus for use in a method of forming conductive tracks on a substrate as claimed in claim 81, wherein the laser is a diode laser.

84. An apparatus for use in a method of forming conductive tracks on a substrate as claimed in claim 81, wherein the laser is a CO₂ laser.

85. An apparatus for use in a method of forming conductive tracks on a substrate as claimed in claim 81, wherein the laser is a pulsed laser.

86. An apparatus for use in a method of forming conductive tracks on a substrate as claimed in claim 81, wherein the laser is a Q-switched solid state laser.

87. An apparatus for use in a method of forming conductive tracks on a substrate as claimed in claim 81, wherein the laser is a Nd³⁺:YAG laser.

88. An apparatus for use in a method of forming conductive tracks on a substrate as claimed in claim 81, wherein the apparatus further comprises means for coating the substrate with a conductive ink to create the conductive ink layer.

89. An apparatus for use in a method of forming conductive tracks on a substrate as claimed in claim 88, wherein the coating means is an ink screening apparatus.

90. An apparatus for use in a method of forming conductive tracks on a substrate as claimed in claim 81, wherein the curing means is an oven.

91. An apparatus for use in a method of forming conductive tracks on a substrate as claimed in claim 90, wherein the oven is a convective oven, conveyor type oven or a vapour phase oven.

92. An apparatus for use in a method of forming conductive tracks on a substrate as claimed in claim 81, wherein the curing means is a UV lamp.

93. An apparatus for use in a method of forming conductive tracks on a substrate as claimed in claim 81, wherein the apparatus further comprises:
means for coating a substrate incorporating cured tracks of ink with a dielectric ink layer;
means for moving the laser relative to the substrate to ablate a portion of the dielectric ink layer from the substrate to define apertures in the dielectric ink layer and expose portions of the cured tracks of ink; and
means for curing said dielectric ink layer.

94. An apparatus for use in a method of forming conductive tracks on a substrate as claimed in claim 93, wherein the apparatus further comprises:
means for coating a substrate incorporating at least one layer of cured tracks of conductive ink and at least one dielectric ink layer with a conductive ink to create a further conductive ink layer;
means for moving the laser relative to the substrate to ablate a portion of the further conductive ink layer to define a further layer of tracks of conductive ink; and
means for curing said further layer of tracks of conductive ink.
